(19) United States
(12) Patent Application Publication
(10) Pub. No.: US 2014/0044011 A1
(43) Pub. Date: Feb. 13, 2014

(54) METHOD, APPARATUS, AND MULTIMODE TERMINAL FOR IMPLEMENTING NETWORK SWITCHING

(71) Applicant: Huawei Device Co., Ltd., Shenzhen (CN)

(72) Inventor: Xuewen ZHAO, Xi'an (CN)

(73) Assignee: Huawei Device Co., Ltd., Shenzhen (CN)

(21) Appl. No.: 14/017,845

(22) Filed: Sep. 4, 2013

Related U.S. Application Data
(63) Continuation of application No. PCT/CN2013/071938, filed on Feb. 27, 2013.

(30) Foreign Application Priority Data
Jul. 3, 2012 (CN) 201210226599.1

(51) Int. Cl. H04L 29/12; H04L 12/24

(52) U.S. Cl. CPC H04L 61/256; H04L 41/0816
USPC 370/254

(57) ABSTRACT

A method, an apparatus, and a multimode terminal for implementing network switching. The method includes: sending a network access request to a second modem module and receiving a network parameter including at least an IP (Internet Protocol) address fed back by the second modem module, where the IP address fed back by the second modem module is the same as an IP address acquired by a first modem module that has accessed a network; disconnecting a communication connection between a NAT (Network Address Translation) module performing address translation and the first modem module; and updating network configuration of the second modem module and establishing a communication connection between the NAT module and the second modem module. The method, apparatus, and multimode terminal disclosed herein can ensure that a service is not interrupted during network switching, thereby improving the user experience and satisfaction.

### CROSS-REFERENCE TO RELATED APPLICATIONS

This application is a continuation of International Patent Application No. PCT/CN2013/071938, filed on Feb. 27, 2013, which claims priority to Chinese Patent Application No. 201210226599.1, filed on Jul. 3, 2012, both of which are hereby incorporated by reference in their entireties.

### TECHNICAL FIELD

The present disclosure relates to the field of communications technologies and, in particular, to a method, an apparatus, and a multimode terminal for implementing network switching.

### BACKGROUND

With the development of wireless communication technologies and the increasing maturity and commercial use of multiple wireless technologies, high rates achieved by high-bandwidth wireless technologies currently have found more and more favor in operators' eyes. Therefore, many operators begin to deploy wireless networks where multiple modes coexist based on an original single wireless network, such as coexistence of a WiMAX (Worldwide Interoperability for Microwave Access, worldwide interoperability for microwave access) network and a 3G (3rd-generation, 3rd generation mobile communication technology) network, coexistence of an LTE (Long Term Evolution, long term evolution) network and a 3G network, and coexistence of a 3G network and another 3G network. Under this technical background, a multimode terminal that is capable of accessing networks of multiple modes and implementing service switching between the networks of multiple modes has emerged.

However, if existing networks of multiple modes coexist, regardless of whether a multimode switching operation is performed, an IP (Internet Protocol, Internet Protocol) address obtained by a multimode terminal from a network side does not change. For example, when a PC (personal computer, personal computer) accesses the Internet by using a multimode terminal, the multimode terminal acquires a public network IP address from an access network, and the PC acquires a private network address from the multimode terminal to implement network access; in addition, to send a packet of the PC to the Internet, the multimode terminal generally uses the NAT (Network Address Translation, network address translation) technology to translate the packet first. Therefore, the multimode terminal needs to maintain a NAT translation table to ensure that a data packet between the PC and the Internet can be correctly forwarded.

However, in a networking scenario shown in FIG. 1, when a multimode terminal performs network switching, that is, when it switches from a network connected to a Modem (modem) A to a network connected to a Modem B, the multimode terminal needs to switch its route from the Modem A to the Modem B, but a translation NAT table cannot be switched from the Modem A to the Modem B. As a result, a data service cannot continue, that is, the data service is interrupted, resulting in a poor user experience.

### SUMMARY

Embodiments of the present disclosure provide a method, an apparatus, and a multimode terminal for implementing network switching, which are capable of ensuring that a service is not interrupted during network switching, thereby improving the user experience and satisfaction.

To solve the preceding problem, the embodiments of the present disclosure provide the following technical solutions:

An embodiment of a first aspect of the present disclosure provides a method for implementing network switching, and its first implementation manner includes:

sending a network access request to a second modem module and receiving a network parameter including at least an IP address fed back by the second modem module, where the IP address fed back by the second modem module is the same as an IP address acquired by a first modem module that has accessed a network; disconnecting a communication connection between a NAT module performing address translation and the first modem module; and updating network configuration of the second modem module and establishing a communication connection between the NAT module and the second modem module.

Optionally, according to the first implementation manner of the embodiment of the first aspect of the present disclosure, a second implementation manner further includes: presetting a configuration unit between multiple modem modules and the NAT module to acquire network parameters acquired by the multiple modem modules and control the NAT module to create and update a NAT translation table; and the disconnecting a communication connection between a NAT module and the first modem module specifically includes: disconnecting a communication connection between the configuration unit and the first modem module, and deleting a network parameter acquired by the first modem module to disconnect the communication connection between the NAT module and the first modem module.

Optionally, according to the second implementation manner of the embodiment of the first aspect of the present disclosure, in a third implementation manner, the updating network configuration of the second modem module and establishing a communication connection between the NAT module and the second modem module specifically includes: updating the network configuration of the second modem module by using the network parameter fed back by the second modem module; restoring a communication connection between the second modem module and the configuration unit; and switching a data service to the second modem module.

Optionally, according to the first implementation manner of the embodiment of the first aspect of the present disclosure, in a fourth implementation manner, the disconnecting a communication connection between a NAT module and the first modem module specifically includes: dissociating a NAT entry in the NAT module from the first modem module; storing a NAT entry associated with the first modem module; and deleting a network parameter configured on the first modem module to disconnect the communication connection between the NAT module and the first modem module.

Optionally, according to the fourth implementation manner of the embodiment of the first aspect of the present disclosure, in a fifth implementation manner, the updating network configuration of the second modem module and establishing a communication connection between the NAT module and the second modem module specifically includes: updating the network configuration of the second modem module by using the network parameter fed back by the second modem module; associating the stored NAT entry with the second modem module; and switching a data service to the second modem module.

An embodiment of a second aspect of the present disclosure provides an apparatus for implementing network switching, and its first implementation manner includes: a sending unit, a receiving unit, a cutting unit, and a communication unit; where the sending unit is configured to send a network access request to a second modem module of a multimode terminal and send a network exit request to a first modem module of the multimode terminal; the receiving unit is configured to receive a network parameter including at least an IP address fed back by the second modem module and receive a network exit success message fed back by the first modem module, where the received IP address is the same as an IP address acquired by a first modem module that has accessed a network; the cutting unit is configured to disconnect a communication connection between a NAT module performing address translation in the multimode terminal and the first modem module after the receiving unit receives the network parameter fed back by the second modem module; and the communication unit is configured to: after the cutting unit completes a cutting operation, update network configuration of the second modem module, establish a communication connection between the NAT module and the second modem module, and instruct the sending unit to send the network exit request.

Optionally, according to the first implementation manner of the embodiment of the second aspect of the present disclosure, in a second implementation manner, the apparatus further includes: a configuration unit set between multiple modem modules and the NAT module, where the configuration unit is configured to acquire network parameters acquired by the multiple modem modules and control the NAT module to create and update a NAT translation table; and the cutting unit further includes: a first processing module disconnecting a communication connection between the configuration unit and the first modem module, and a first deleting module deleting a network parameter acquired by the first modem module after the first processing module completes a disconnecting operation.

Optionally, according to the second implementation manner of the embodiment of the second aspect of the present disclosure, in a third implementation manner, the communication unit further includes: a first updating module, a restoring module, and a first switching module, where the first updating module is configured to update the network configuration of the second modem module by using the network parameter fed back by the second modem module; the restoring module is configured to restore a communication connection between the second modem module and the configuration unit after the first updating module completes an updating operation; and the switching module is configured to switch a data service to the second modem module after the restoring module completes communication connection restoration.

Optionally, according to the first implementation manner of the embodiment of the second aspect of the present disclosure, in a fourth implementation manner, the cutting unit further includes: a dissociating module, a storage module, and a second deleting module, where the dissociating module is configured to dissociate a NAT entry in the NAT module from the first modem module; the storage module is configured to store a NAT entry associated with the first modem module; and the second deleting module is configured to delete a network parameter configured on the first modem module after the storage module completes a storage operation.

Optionally, according to the fourth implementation manner of the embodiment of the second aspect of the present disclosure, in a fifth implementation manner, the communication unit further includes: a second updating module, an associating module, and a second switching module; where the second updating module is configured to update the network configuration of the second modem module by using the network parameter fed back by the second modem module; the associating module is configured to associate the NAT entry stored by the storage module with the second modem module after the second updating module completes an updating operation; and the second switching module is configured to switch a data service to the second modem module after the associating module completes an associating operation.

An embodiment of a third aspect of the present disclosure provides a multimode terminal for implementing network switching, and its first implementation manner includes a NAT module performing address translation and multiple modem modules where the multimode terminal further includes: a sending unit, a receiving unit, a cutting unit, and a communication unit; where the sending unit is configured to send a network access request to a second modem module and send a network exit request to a first modem module; the receiving unit is configured to receive a network parameter at least including an IP address fed back by the second modem module and receive a network exit success message fed back by the first modem module, where the received IP address is the same as an IP address acquired by a first modem module that has accessed a network; the cutting unit is configured to disconnect a communication connection between a NAT module performing address translation and the first modem module after the receiving unit receives the network parameter fed back by the second modem module; and the communication unit is configured to: after the cutting unit completes a cutting operation, update network configuration of the second modem module, establish a communication connection between the NAT module and the second modem module, and instruct the sending unit to send the network exit request.

As can be seen from the above, during network switching performed by using the method, the apparatus, and the multimode terminal of the embodiments of the present disclosure, a communication connection between a NAT module implementing address translation and a modem module accessing an original network is disconnected, and a communication connection is established between another modem module accessing a new network and the NAT module after the another modem module is configured with a relevant network parameter, so as to ensure that the link information and rule of a NAT translation table do not change in the network switching process. As a result, no IP address needs to be reconfigured. This ensures that a service is not interrupted during network switching, thereby improving the user experience and satisfaction.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of a network topology of traditional network switching according to an embodiment of the present disclosure;

FIG. 2 is a schematic flowchart of a method for implementing network switching according to an embodiment of the present disclosure;

FIG. 3 is another schematic flowchart of a method for implementing network switching according to an embodiment of the present disclosure;

FIG. 4 is still another schematic flowchart of a method for implementing network switching according to an embodiment of the present disclosure; and

FIG. 5 is a schematic structural diagram of an apparatus for implementing network switching according to an embodiment of the present disclosure.

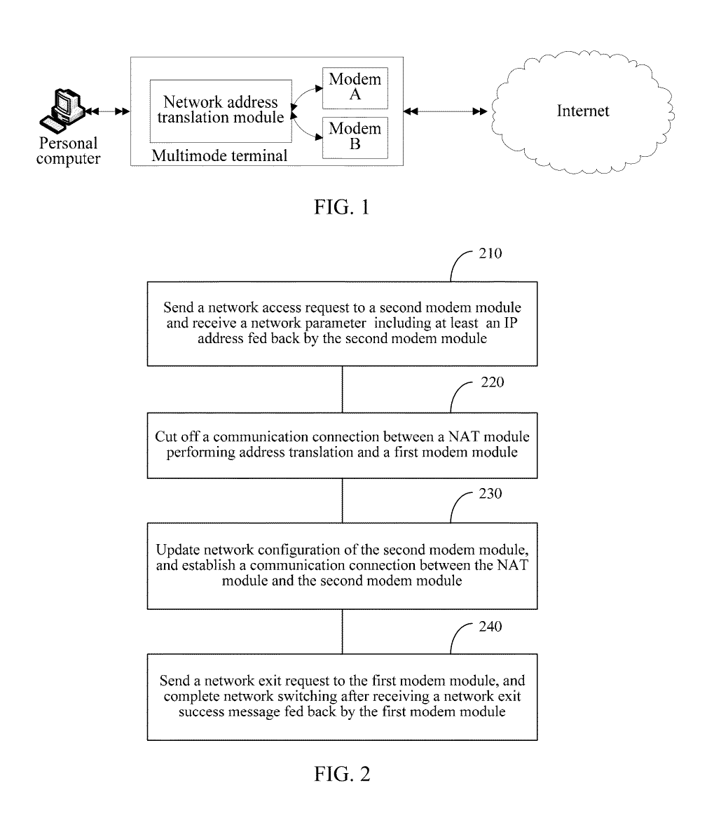

### DESCRIPTION OF EMBODIMENTS

The following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

One concept of the embodiments of the present disclosure is that during network switching, a change of an upper-layer network parameter is isolated to ensure that the link information and rules of a NAT translation table do not change, so that no IP (Internet Protocol) address needs to be reconfigured, thereby ensuring that a service is not interrupted during network switching and improving the user experience and satisfaction.

An embodiment of the present disclosure provides a method for implementing network switching, as shown in FIG. 2. The method includes:

Step 210: When network switching needs to be performed, an MCM (Multimode control module, multimode control module) of a multimode terminal sends a network access request to a second modem module and receive a network parameter at least including an IP address fed back by the second modem module, where the IP address fed back by the second modem module is the same as an IP address acquired by a first modem module that has accessed a network.

The network parameter fed back by the second modem module may further include: a router address, a DNS (Domain Name System, domain name system) server address, and so on, but this embodiment is not limited thereto. The first modem module and second modem module mentioned in this embodiment do not have any sequential relationship, both serve as merely examples of modem modules in different connection states, and both are the same from the perspectives of network access and their functions, and no further details are provided herein.

When a data packet is sent through a router in an internal network having a private address, a NAT technology may be used to translate the private address into a valid IP address, thereby ensuring that a local area network may implement communication requirements of all PCs with the Internet in a private address network by using only a small amount of IP addresses. Therefore, before and after performing network switching, the multimode terminal must acquire a same IP address to ensure that a NAT translation rule of the multimode terminal does not change, thereby ensuring that a data service is not interrupted and may proceed normally. Accordingly, this embodiment puts forward that during network switching, when a network access request is sent to a modem module accessing a target network, a received IP address fed back by the modem module needs to be the same as an IP address acquired by another modem module that has currently accessed a network, so as to ensure that a NAT translation rule of a NAT module implementing address translation does not change during network switching. Specifically, in the prior art, there already exists a system that is capable of enabling multiple modem modules to acquire a same IP address, and no further details are provided herein.

Step 220: Cut off, or disconnect, a communication connection between a NAT module performing address translation and the first modem module.

In this embodiment, the disconnecting a communication connection between a NAT module and the first modem module may be implemented in multiple manners, for example, but not limited to, the following two manners The specific manner is not limited in this embodiment.

A. Preset a configuration unit between multiple modem modules and the NAT module to acquire network parameters acquired by the multiple modem modules and control the NAT module to create and update a NAT translation table; and during network switching, disconnect a communication connection between the configuration unit and the first modem module, and delete a network parameter acquired by the first modem module to disconnect the communication connection between the NAT module and the first modem module.

B. During network switching, dissociate a relevant NAT entry in the NAT module from the first modem module, store a NAT entry associated with the first modem module in a buffer area, and then delete a network parameter, for example, information such as an IP address and a route, configured on the first modem module to disconnect the communication connection between the NAT module and the first modem module.

Step 230: Update network configuration of the second modem module, and establish a communication connection between the NAT module and the second modem module.

Specifically, in this embodiment, the updating network configuration of the second modem module and establishing a communication connection between the NAT module and the second modem module may be implemented in multiple manners, for example, but not limited to, the following two manners The specific manner is not limited in this embodiment.

A. Update the network configuration of the second modem module by using the network parameter fed back by the second modem module, for example, update a routing table, a DNS server address, and so on, according to the router address in the network parameter, and then restore a communication connection between the second modem module and the preset configuration unit to establish the communication connection between the NAT module and the second modem module and switch a data service to the second modem module.

B. Update the network configuration of the second modem module by using the network parameter fed back by the second modem module, associate the NAT entry stored in the buffer area with the second modem module to establish the communication connection between the NAT module and the second modem module, and then configure route information according to the router address in the network parameter to switch a data service to the second modem module.

Step 240: Send a network exit request to the first modem module, and complete network switching after receiving a network exit success message fed back the first modem module.

After the communication connection between the NAT module and the second modem module is established, which means that the data service has been successfully switched to the second modem module and accesses a new network by using the second modem module, the MCM of the multimode terminal sends the network exit request to the first modem module, so that the first modem module disconnects a connection with an original network; and after receiving the network exit request sent by the MCM, the first modem module disconnects the connection with the original network and feeds back a network exit success response to the MCM to inform the MCM of the network exit success.

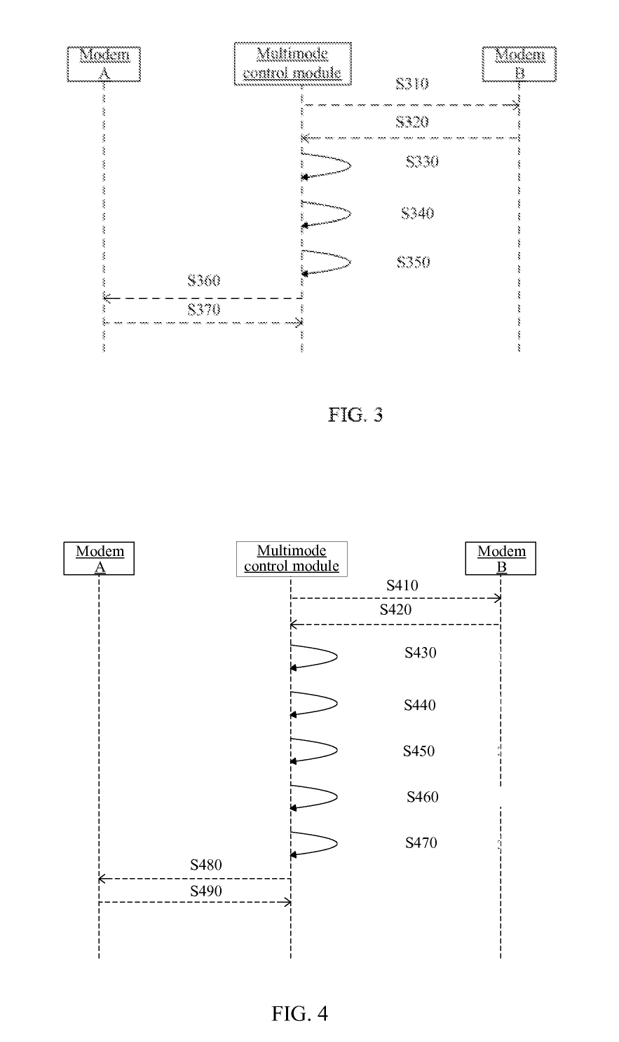

The following describes in detail the method for implementing network switching in the preceding embodiment by using a specific example. As shown in FIG. 3, a Modem A and a Modem B are two modem modules included in a multimode terminal, where the Modem A has accessed a network and is capable of normally performing a data service, and an MCM is a multimode switching control module controlling a network switching operation inside the multimode terminal. The method includes:

S310: When network switching needs to be performed, the MCM of the multimode terminal sends a network access request to the Modem B.

S320: The Modem B accesses a new network according to the received network access request and feeds back response information to the MCM after acquiring network parameters such as an IP address and a router address, where the IP address fed back by the Modem B to the MCM is the same as an IP address acquired by the Modem A that has accessed the network.

S330: Preset a configuration unit between the Modem A and Modem B and a NAT module to acquire network parameters acquired by the modem modules and control the NAT module to create and update a NAT translation table; after the MCM receives the response information fed back by the Modem B, disconnect a communication connection between the configuration unit and the Modem A, and delete a network parameter acquired by the Modem A to disconnect a communication connection between the NAT module and the Modem A.

S340: The MCM updates network configuration of the Modem B by using parameters, such as an IP address and a router address, fed back by the Modem B.

S350: Establish a communication connection between the Modem B and the configuration unit to establish a communication connection between the NAT module and the Modem B.

S360: The MCM sends a network exit request to the Modem A.

S370: After receiving the network exit request, the Modem A disconnects a connection with an original network and feeds back a network exit success response message to the MCM to complete network switching.

The following describes in detail the method for implementing network switching in the preceding embodiment by using another specific example. As shown in FIG. 4, a Modem A and a Modem B are two modem modules included in a multimode terminal, where the Modem A has accessed a network and is capable of normally performing a data service, and an MCM is a multimode switching control module controlling a network switching operation inside the multimode terminal. The method includes:

S410: When network switching needs to be performed, the MCM of the multimode terminal sends a network access request to the Modem B.

S420: The Modem B accesses a new network according to the received network access request and feeds back response information to the MCM after acquiring network parameters such as an IP address and a router address, where the IP address fed back by the Modem B to the MCM is the same as an IP address acquired by the Modem A that has accessed the network;

S430: The MCM dissociates a relevant NAT entry in the NAT module from the Modem A and stores a NAT entry associated with the Modem A in a buffer area.

S440: The MCM deletes a network parameter, for example, information such as an IP address and a route, configured on the Modem A to disconnect a communication connection between the NAT module and the Modem A.

S450: The MCM updates the network configuration of the Modem B according to a network parameter fed back by the Modem B.

S460: The MCM associates the NAT entry stored in the buffer area with the Modem B to establish a communication connection between the NAT module and the Modem B.

S470: The MCM configures route information of the Modem B according to a router address in the network parameter to switch a data service to the Modem B.

S480: The MCM sends a network exit request to the Modem A.

S490: After receiving the network exit request, the Modem A disconnects a connection with an original network and feeds back a network exit success response message to the MCM to complete network switching.

As can be seen from the above, during network switching performed by using the method of the embodiment of the present disclosure, a communication connection between a NAT module implementing address translation and a modem module accessing an original network is disconnected, and a communication connection is established between another modem module accessing a new network and the NAT module after the another modem module is configured with a relevant network parameter, so as to ensure that the link information and rule of a NAT translation table do not change in the network switching process. In this way, no IP address needs to be reconfigured, thereby ensuring that a service is not interrupted during network switching and improving the user experience and satisfaction.

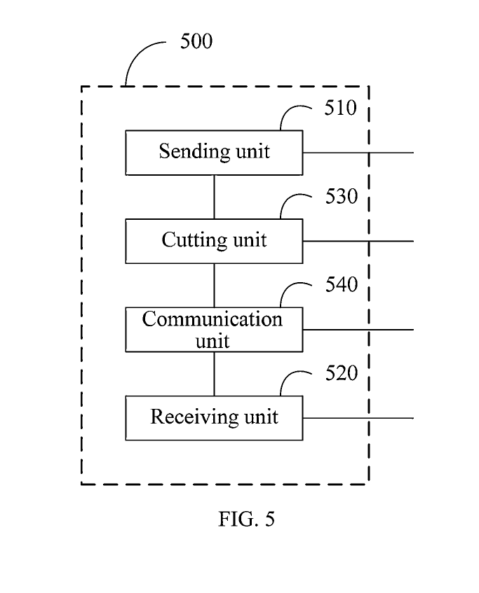

Based on the same concept, another embodiment of the present disclosure also provides an apparatus for implementing network switching. As shown in FIG. 5, the apparatus 500 includes: a sending unit 510, a receiving unit 520, a cutting unit 530, and a communication unit 540.

The sending unit 510 is configured to send a network access request to a second modem module of a multimode terminal and send a network exit request to a first modem module of the multimode terminal; the receiving unit 520 is configured to receive a network parameter at least including an IP address fed back by the second modem module and receive a network exit success message fed back by the first modem module, where the received IP address is the same as an IP address acquired by a first modem module that has accessed a network; the cutting unit 530 is configured to cut off, or disconnect, a communication connection between a NAT module performing address translation in the multimode terminal and the first modem module after the receiving unit 520 receives the network parameter fed back by the second modem module; and the communication unit 540 is configured to: after the cutting unit 530 completes a cutting operation, update network configuration of the second modem module, establish a communication connection between the NAT module and the second modem module, and instruct the sending unit 510 to send the network exit request.

The apparatus 500 may further include (not shown in FIG. 5): a configuration unit set between multiple modem modules and the NAT module, where the configuration unit is configured to acquire network parameters acquired by the multiple modem modules and control the NAT module to create and update a NAT translation table; based on this, the cutting unit 530 may further include (not shown in FIG. 5): a first processing module disconnecting a communication connection between the configuration unit and the first modem module, and a first deleting module deleting a network parameter acquired by the first modem module after the first processing module completes a disconnecting operation.

In addition, the communication unit 540 may further include (not shown in FIG. 5): a first updating module, a restoring module, and a first switching module, where the first updating module is configured to update the network configuration of the second modem module by using the network parameter fed back by the second modem module; the restoring module is configured to restore a communication connection between the second modem module and the configuration unit after the first updating module completes an updating operation; and the switching module is configured to switch a data service to the second modem module after the restoring module completes communication connection restoration.

In addition, the cutting unit 530 may further include (not shown in FIG. 5): a dissociating module, a storage module, and a second deleting module. where the dissociating module is configured to dissociate a NAT entry in the NAT module from the first modem module; the storage module is configured to store a NAT entry associated with the first modem module; and the second deleting module is configured to delete a network parameter configured on the first modem module after the storage module completes a storage operation.

Based on this, the communication unit 540 may further include (not shown in FIG. 5): a second updating module, an associating module, and a second switching module, where the second updating module is configured to update the network configuration of the second modem module by using the network parameter fed back by the second modem module; the associating module is configured to associate the NAT entry stored by the storage module with the second modem module after the second updating module completes an updating operation; and the second switching module is configured to switch a data service to the second modem module after the associating module completes an associating operation.

In addition, another embodiment of the present disclosure also provides a processor for implementing network switching, where the processor is configured to send a network access request to a second modem module of a multimode terminal, send a network exit request to a first modem module of the multimode terminal, receive a network parameter including at least an IP address fed back by the second modem module, and receive a network exit success message fed back by the first modem module, where the received IP address is the same as an IP address acquired by a first modem module that has accessed a network; after receiving the network parameter fed back by the second modem module, the processor cuts off a communication connection between a NAT module performing address translation in the multimode terminal and the first modem module, updates network configuration of the second modem module, establishes a communication connection between the NAT module and the second modem module, and instructs the sending unit to send the network exit request to complete network switching.

A person skilled in the art may easily understand, various apparatuses for implementing network switching in the preceding embodiments may exist as a part of a multimode terminal, and their implementation of network switching in the multimode terminal is the same as that described in the preceding embodiments. Therefore, a multimode terminal that includes the apparatuses for implementing network switching in the preceding embodiments shall also fall within the protection scope of the present disclosure, and details are not provided herein.

A person skilled in the art may further appreciate that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of every embodiment according to functions. Whether these functions are performed by hardware or software depends on particular applications and design constraint conditions of the technical solutions. A person skilled in the art may use different methods to implement the described functions for each particular application, but it should not be considered that the implementation goes beyond the scope of the embodiments of the present disclosure.

The steps of the methods or algorithms described in combination with the embodiments herein may be implemented using hardware, a software module executed by a processor, or the combination thereof

A person skilled in the art may implement or use the embodiments of the present disclosure based on the foregoing descriptions of the disclosed embodiments. Multiple modifications to these embodiments are apparent for a person skilled in the art. The general principle defined in the present disclosure may be implemented in other embodiments without departing from the spirit or scope of the embodiments of the present disclosure. Therefore, the embodiments of the present disclosure will not be limited to the embodiments described in the document but extends to the widest scope that complies with the principle and novelty disclosed in the document.

The foregoing describes only exemplary embodiments of the present disclosure and is not intended to limit the embodiments of the present disclosure. Any modification, equivalent replacement, or improvement made without departing from the spirit and principle of the embodiments of the present disclosure shall fall within the protection scope of the embodiments of the present disclosure.

What is claimed is:

1. A method for implementing network switching, the method comprising:
sending a network access request to a second modem module and receiving a network parameter comprising at least an IP (Internet Protocol) address fed back by the second modem module, wherein the IP address fed back by the second modem module is the same as an IP address acquired by a first modem module that has accessed a network;
disconnecting a communication connection between a NAT (Network Address Translation) module performing address translation and the first modem module; and
updating a network configuration of the second modem module and establishing a communication connection between the NAT module and the second modem module.

2. The method according to claim 1, further comprising:
presetting a configuration unit between multiple modem modules and the NAT module to acquire network parameters acquired by the multiple modem modules and control the NAT module to create and update a NAT translation table;
wherein the disconnecting the communication connection between a NAT module and the first modem module comprises: disconnecting a communication connection between the configuration unit and the first modem module, and deleting a network parameter acquired by the first modem module to disconnect the communication connection between the NAT module and the first modem module.

3. The method according to claim 2, wherein the updating the network configuration of the second modem module and establishing the communication connection between the NAT module and the second modem module comprises:
updating the network configuration of the second modem module by using the network parameter fed back by the second modem module;
restoring a communication connection between the second modem module and the configuration unit; and
switching a data service to the second modem module.

4. The method according to claim 1, wherein the disconnecting the communication connection between the NAT module and the first modem module comprises:
dissociating a NAT entry in the NAT module from the first modem module;
storing a NAT entry associated with the first modem module; and
deleting a network parameter configured on the first modem module to disconnect the communication connection between the NAT module and the first modem module.

5. The method according to claim 4, wherein the updating network configuration of the second modem module and establishing the communication connection between the NAT module and the second modem module comprises:
updating the network configuration of the second modem module by using the network parameter fed back by the second modem module;
associating the stored NAT entry with the second modem module; and
switching a data service to the second modem module.

6. An apparatus for implementing network switching, comprising:
a sending unit;
a receiving unit;
a cutting unit; and
a communication unit,
wherein the sending unit is configured to send a network access request to a second modem module of a multimode terminal and send a network exit request to a first modem module of the multimode terminal;
wherein the receiving unit is configured to receive a network parameter comprising at least an IP (Internet Protocol) address fed back by the second modem module and receive a network exit success message fed back by the first modem module, wherein the received IP address is the same as an IP address acquired by a first modem module that has accessed a network;
wherein the cutting unit is configured to disconnect a communication connection between a NAT (Network Address Translation) module performing address translation in the multimode terminal and the first modem module after the receiving unit receives the network parameter fed back by the second modem module; and
wherein the communication unit is configured to: after the cutting unit completes a cutting operation, update network configuration of the second modem module, establish a communication connection between the NAT module and the second modem module, and instruct the sending unit to send the network exit request.

7. The apparatus according to claim 6, further comprising:
a configuration unit set between multiple modem modules and the NAT module, wherein the configuration unit is configured to acquire network parameters acquired by the multiple modem modules and control the NAT module to create and update a NAT translation table;
wherein the cutting unit further comprises: a first processing module disconnecting a communication connection between the configuration unit and the first modem module, and a first deleting module deleting a network parameter acquired by the first modem module after the first processing module completes a disconnecting operation.

8. The apparatus according to claim 7, wherein the communication unit further comprises a first updating module, a restoring module, and a first switching module, wherein:
the first updating module is configured to update the network configuration of the second modem module by using the network parameter fed back by the second modem module;
the restoring module is configured to restore a communication connection between the second modem module and the configuration unit after the first updating module completes an updating operation; and
the switching module is configured to switch a data service to the second modem module after the restoring module completes communication connection restoration.

9. The apparatus according to claim 6, wherein the cutting unit further comprises a dissociating module, a storage module, and a second deleting module, wherein:
the dissociating module is configured to dissociate a NAT entry in the NAT module from the first modem module;
the storage module is configured to store a NAT entry associated with the first modem module; and
the second deleting module is configured to delete a network parameter configured on the first modem module after the storage module completes a storage operation.

10. The apparatus according to claim 9, wherein the communication unit further comprises a second updating module, an associating module, and a second switching module, wherein:
the second updating module is configured to update the network configuration of the second modem module by using the network parameter fed back by the second modem module;
the associating module is configured to associate the NAT entry stored by the storage module with the second modem module after the second updating module completes an updating operation; and
the second switching module is configured to switch a data service to the second modem module after the associating module completes an associating operation.

11. A multimode terminal for implementing network switching, comprising a NAT (Network Address Translation) module performing address translation and multiple modem modules, wherein the multimode terminal further comprises a sending unit, a receiving unit, a cutting unit, and a communication unit, wherein:
the sending unit is configured to send a network access request to a second modem module and send a network exit request to a first modem module;
the receiving unit is configured to receive a network parameter comprising at least an IP address fed back by the second modem module and receive a network exit success message fed back by the first modem module, wherein the received IP address is the same as an IP address acquired by a first modem module that has accessed a network;
the cutting unit is configured to disconnect a communication connection between a NAT module performing address translation and the first modem module after the receiving unit receives the network parameter fed back by the second modem module; and
the communication unit is configured to: after the cutting unit completes a cutting operation, update network configuration of the second modem module, establish a communication connection between the NAT module and the second modem module, and instruct the sending unit to send the network exit request.

12. A processor for implementing network switching, wherein the processor is configured to send a network access request to a second modem module of a multimode terminal, send a network exit request to a first modem module of the multimode terminal, receive a network parameter including at least an IP (Internet Protocol) address fed back by the second modem module, and receive a network exit success message fed back by the first modem module, wherein the received IP address is the same as an IP address acquired by a first modem module that has accessed a network; after receiving the network parameter fed back by the second modem module, disconnect a communication connection between a NAT (Network Address Translation) module performing address translation in the multimode terminal and the first modem module, update network configuration of the second modem module, establish a communication connection between the NAT module and the second modem module, and send the network exit request to complete network switching.
